(19) United States
(12) Patent Application Publication
(10) Pub. No.: US 2009/0019396 A1
(43) Pub. Date: Jan. 15, 2009

(54) User Programmable Key in a User Interface System

(75) Inventor: Dennis J. McCarthy, Glen Ellen, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/775,879

(22) Filed: Jul. 11, 2007

(51) Int. Cl. G06F 3/048

(52) U.S. Cl. 715/827

(57) ABSTRACT

A User Programmable Key resides on an instrument to assist a user to access and execute preferred features of the instrument in a minimal amount of time. A feature or a set of features are programmed into the User Programmable Key by a user from some or all of the available features in an instrument. The User Programmable Key is assigned to an area adjacent or on the graphical user interface and visible while a user accesses other available buttons, menus or features of an instrument's menu tree.

### BACKGROUND OF THE INVENTION

Hardware and software functionality of contemporary electronic instruments is accessible through context menus. The term context menu is commonly used for menus and sub-menus which appear on a graphical user interface, offering a list of options which vary depending on the context of the action, the application running, and the item selected. Context menus are often hierarchically organized, allowing navigation through different levels of the menu structure. A context menu is typically invoked by a button or a key marked with a specific feature, called a Labeled Hard Key (LHK), presented on the instrument's front panel for a user to traverse a list of features available within an instrument's features.

To compliment an LHK or a group of LHKs, instrument manufacturers have designed into their front panels a set of unlabeled buttons whereby menu options corresponding to a user selected LHK are displayed alongside the unlabeled buttons. The unlabeled buttons, also referred to as soft key buttons (SKBs) are paired with labels; a column of labels referred to as a soft key menu (SKM). Together they are referred to as soft keys (SKs). Various features can be mapped onto SKs. SKs are reassigned and relabeled to allow a user to methodologically traverse many levels of a menu tree in order to reach features provided by a manufacturer.

Complex and advanced instruments have a tall menu tree to enable access to the multitude of features available. A general user interface provides access to all features and organizes all settings and operations into categories and subcategories of a menu tree structure having a depth of as many as six levels or more. As users rarely make use of all the instrument's features, only a subset of overall available features is used throughout the tenure of an instrument.

FIG. 1 shows a front panel of an electronic instrument of the prior art. In particular, the figure highlights a graphical user interface, soft keys and labeled hard keys.

A user invokes features of the electronic instrument by selecting an LHK from a cluster of LHKs 20 on a front panel 100 of FIG. 1. Feature categories assist the user in commencing an action, and in FIG. 1 the cluster of LHKs is grouped into feature categories 21, 22, 23 and 24 to provide the user with visual assistance in beginning an action.

A set of SKBs 30 arranged along the side of graphical user interface (GUI) 50, and a corresponding SKM column 40 appears within the GUI immediately adjacent to the soft keys. When a labeled hard key from cluster 20 is pressed, the SKM column is drawn with labels corresponding to the actions of the labeled hard key.

An example to illustrate operating the instrument of FIG. 1 is described herewith. When LHK 25 is selected to initiate a feature termed ‘Traces’, an SKM column 40 is created with an SKM heading 41 corresponding to LHK 25 and labels 42, 43, 44, 45, 46 and 47 indicating actions under the SKM heading.

When SKB 32 is pressed, an action indicated by screen label 44 executes. In some cases, a screen label expands into another sub-menu of features resulting in the SKM column 40 being redrawn with new labels found in that sub-menu. Otherwise, the SKM label is an immediate action label which results in a feature being executed when SKB 32 is selected.

The design described in the prior art allows for accessing a large number of an instrument's features with a limited number of LHKs and SKs. As features are categorized in a hierarchical tree structure, a finite number of labeled hard keys and a number of soft keys are designed into a front panel 100 to create a comprehensive browsing environment.

One disadvantage of the prior art implementation is accessing capabilities mapped deep within the menu structure. As such, many keystrokes are required to access a particular feature. As a corollary, it is also tedious when instructing another user of the procedure to reach a required feature.

Features used frequently by a user are not usually found within close proximity in a menu tree, but are rather scattered throughout the overall tree. Thus, a second disadvantage inherent to this design is that a user must sift through a tall, multilevel tree of soft keys, repeatedly clicking through settings and operations that the operator intends to use frequently.

A continuing debate in implementing new functionality to an instrument ensues between manufacturers and customers. Advocates of more keys point out the benefit of reducing the number of key strokes to get to all features. Proponents of fewer keys note the friendliness and simplicity of a sparer front panel. When deciding the answer to this debate it is important to consider the amount of use the customer makes of a given feature.

Accordingly, a need exists to make it easier to locate features that are placed deep within a multi-level menu structure in order to reduce the number of keystrokes and the amount of time needed to access frequently accessed features to improve the usability of a user interface.

### BRIEF DESCRIPTION OF THE DRAWINGS

FIG. 1 is a prior art front panel of an electrical instrument illustrating labeled hard keys, soft keys, soft key menus and a graphical user interface;

FIGS. 2A-B illustrate front panels utilizing two embodiments of the present invention;

FIG. 3 is another view of the embodiment of FIG. 2A;

FIG. 4 is a diagram of a Soft Key menu map and the assignment of features to a User Defined Menu of the embodiment of FIGS. 2A-B; and

FIG. 5 is a flow chart describing a sequence that an instrument will perform when executing instructions relating to implementing the embodiments of the invention.

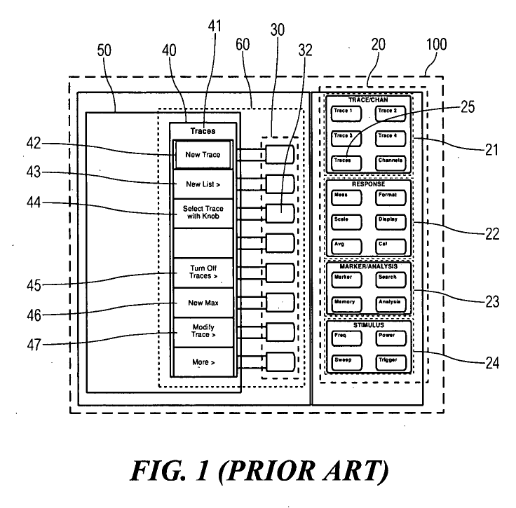

### DETAILED DESCRIPTION

An embodiment of the invention includes a user key, herewith referred to as a User Programmable Key (UPK), on the front panel of an instrument with combined attributes of a labeled hard key and a soft key to enhance a user interface with the instrument.

A UPK may represent a feature or a subset of features frequently accessed by a user. The subset of features can be a manufacture-set sub-menu or a user created sub-menu of features. A UPK is located adjacent to a graphical user interface and situated beside labeled hard keys and soft keys on an instrument's front panel such that the UPK is within short reach and its label and button are conspicuous during operation of the instrument. The customized UPK label and button do not change when a menu is redrawn as an instrument's features are selected. A UPK can take the form of a physical button or a virtual button on a touch screen graphical user interface.

A UPK enables the manufacturer to introduce new features and makes it possible for a customer to promote a feature as needed to the highest level of the user interface. By having a UPK, a manufacturer bypasses justifying how popular a feature is by empowering the customer to decide on a feature to promote to the front panel.

In addition to the attributes mentioned above, during testing and debugging of a new feature a manufacturer may reserve a UPK for the new feature thereby reducing the need to modify existing bug-free features.

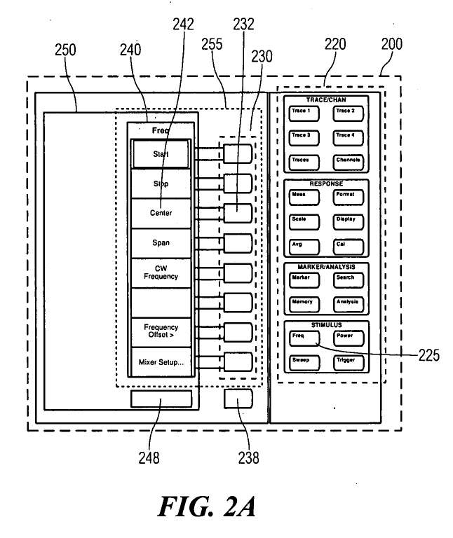

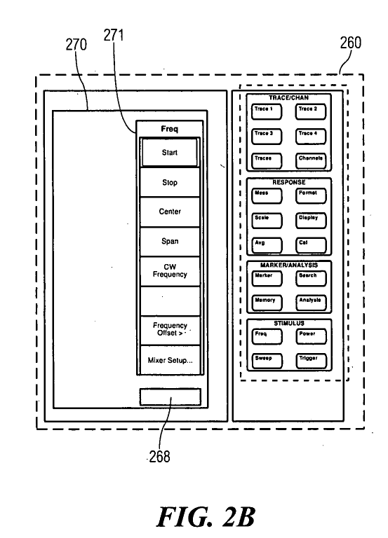

FIG. 2A is an image of a front panel 200 on an electronic test instrument incorporating the inventive feature. The front panel has a cluster of labeled hard keys (LHKs) 220 and soft keys 255. The soft keys (SKs) include a column of soft key buttons (SKBs) 230 and a soft key menu (SKM) column 240. A graphical user interface (GUI) 250 is adjacent to the SKBs. SKM column 240 is visible on the GUI with labels corresponding to features that will be performed by the instrument if the corresponding SKBs are invoked. (The SKM is may also be referred to as ‘menu’.) An embodiment of the present invention, UPK 238 is located below the column of soft key buttons 230.

The LHKs and SKs afford a user access to the myriad of features available in a sophisticated electronic instrument, such as the one shown in of FIG. 2A.

A user intending to execute an action will begin by selecting a labeled feature from the cluster of LHKs 220 provided for by the instrument's manufacturer. Once an LHK is selected, the soft key menu column 240 is drawn with labels corresponding to the features of the selected labeled hard key.

In this embodiment, a UPK 238 is a physical button on the front panel 200 of an instrument located below the column of soft key buttons and is available to a user to program or customize. A UPK label 248 to identify a feature corresponding to the UPK is reserved below Soft Key Menu column 240 and in line with the UPK 238. In FIG. 2A, UPK label 248 is not yet assigned to an existing feature.

As an example to illustrate a user's navigation through a menu tree, an LHK 225 labeled ‘Freq’ is selected to execute an action from a feature category called ‘Stimulus’. This action redraws the SKM column 240 of the GUI to show a sub-menu of options available to a user. The user subsequently selects a desired option which could lead to the SKM column being redrawn with another sub-menu or the execution of an immediate action feature.

The UPK button 238 and label 248 are visible to a user as menus change, and as the user traverses the menu tree. In FIG. 2A, if the user selects label “Center” 242 by depressing soft key button 232 an action will execute but UPK label 248 will not be redrawn.

FIG. 2B is a front panel 260 on an electronic test instrument and incorporates the inventive feature using a touch screen GUI 270. FIG. 2B is similar to that of FIG. 2A except that the front panel 260 of the instrument does not have physical soft key buttons but incorporates soft keys 271 as virtual buttons and labels on the touch screen GUI 270 panel.

The embodiment of a UPK 268 in FIG. 2B is a virtual button to match the characteristics of existing soft keys 271. The same UPK 268 is always visible to the user as soft keys 271 are redrawn.

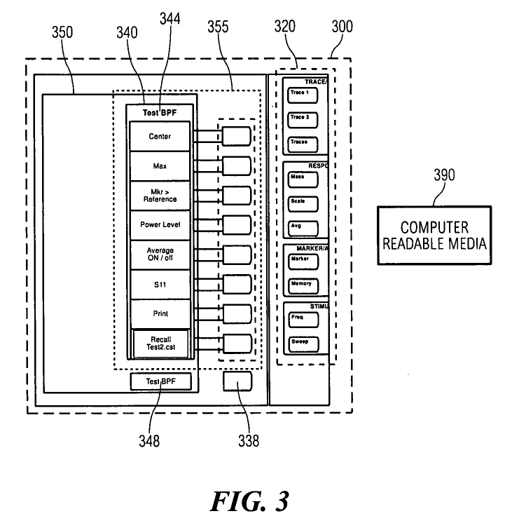

A UPK enhances a user's interactive experience by providing a link to a frequently accessed feature, a set a set of menus within a menu tree or a customized sub-menu of desired features. FIG. 3 is a front panel 300 of an instrument incorporating this inventive feature. A user programmable key 338 and its UPK label 348 are shown in a similar layout as the front panel 200 in FIG. 2A. In FIG. 3 the UPK label 348 has been programmed and displays a label as “Test BPF”.

When a user selects UPK 338, an SKM 340 is redrawn on GUI 350, listing manufacturer-set features (made available by the manufacturers of the equipment). The list of features displayed in the SKM would be no different from that of a sub-menu displayed when the user traversed the menu tree by commencing with an LHK from LHK group 320. A heading 344 of the Soft Key Menu 340 also replicates the UPK label 348 to indicate the user's selection.

The user then continues interacting with the instrument by selecting an action from the soft keys 355.

FIG. 3 also describes computer readable media 390 containing code for providing instructions to and for execution by the instrument 300 in an embodiment of the invention. The computer readable media 390 can be, for example, a ROM, a RAM, a DVD, a hard drive or other computer readable media known in the art.

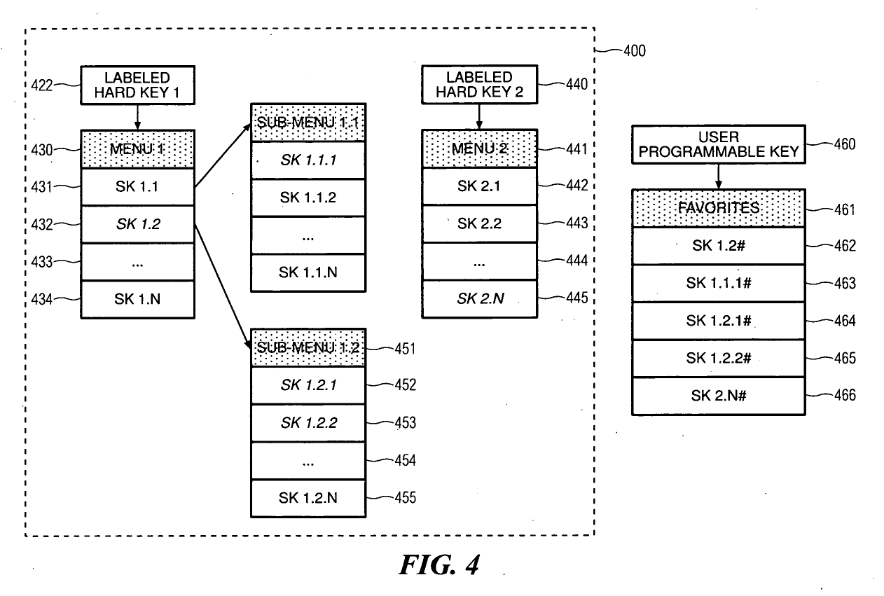

Individual features from multiple sub-menus can be amalgamated and displayed onto a single user defined menu (UDM) using the UPK. FIG. 4 is a block diagram representing a menu tree 400 of a complex instrument. The menu tree depicts top level menus 422 and 440 that correspond to the labeled hard keys on a front panel while sub-menus 430 to 434, 451 to 455 and 441 to 445 represent soft keys on the front panel. FIG. 4 also illustrates a user programmable key 460 with an assignment of manufacturer-set features to the UDM 461.

In the block diagram shown in FIG. 4, the features within the UDM 461 are menu items short listed by a user to replicate existing features often found deep within an instrument's menu tree. The user has selected five features from an instrument's menu tree 400; SK 1.2#, SK 1.1.1#, SK 1.2.1#, SK 1.2.2# and SK 1.2.N# (reference numeral 462, 463, 464, 465 and 466 respectively) as entries into UDM 461.

User defined menu items SK 1.2# and SK 2.N# (reference numerals 462 and 466) are referenced as examples to illustrate the use and creation of a UDM herewith.

Referring to FIG. 4, a user selects Labeled Hard Key 1 (represented in the menu tree by reference numeral 422) from the instrument's front panel and Menu 1 (reference numeral 430) is displayed on the instrument's GUI as labels for the SKs. The labels are a list of manufacturer-set features indicated by reference numerals 431 to 434.

Soft key label indicated by sub-menu SK 1.2 (reference numeral 432) is chosen as an entry to UDM 461. This label will now appear as sub-menu item 462 in the UDM.

Another UDM item SK 2.N# (reference numeral 466) is an immediate action feature that was added from within Hard Key 2 (reference numeral 424). Menu 2 (reference numeral 441) displays labels 442 to 445 onto soft keys of an instrument's GUI. Feature SK 2.N (reference numeral 445) is selected as an entry to UDM 461 and is presented as UDM item SK 2.N# (reference numeral 466).

When UPK 460 is selected by a user from the instrument's front panel, UDM 461 is drawn as SKs on an instrument's GUI listing features described by labels 462 to 466.

If menu item 462 is selected by a user, a sub-menu is redrawn on the instrument's GUI displaying labels illustrated in Sub-Menu 1.2 (reference numeral 451). The user can then proceed with selecting from features 452 to 455. When a user selects menu item 466 from the UPM 461, an immediate action is performed that is identical to selecting the immediate action from menu item 445 of the menu tree 400.

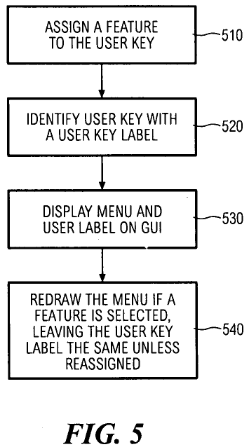

FIG. 5 is a flow chart that describes a sequence an instrument will perform when executing instructions related to implementing the embodiments of the invention. The code resides on the computer readable media 390 described above with reference to FIG. 3 and is used by a Central Processing Unit within an instrument to execute the instructions. Alternatively, the code can be executed by a computer external to the instrument which controls the instrument. Block 510 describes assigning a feature of the instrument to a UPK in response to an action by the user (described below).

In Block 520, instructions are defined to identify a label with the UPK corresponding to the feature assigned to the user programmable key. The user key label is a text label or a graphic icon that can best represent the feature in the space provided for a label on a GUI. Subsequently, Block 530 instructs an instrument to display the menu and the user key label on a graphical user interface where the menu is a subset of features from a hierarchal menu tree of the instrument.

Lastly, Block 540 describes redrawing the menu on the GUI to display a different subset of features from the hierarchal menu tree and to display the user key label with the feature assigned to the UPK. As an example to illustrate executing this instruction, a user may select a feature on the menu or the user programmable key that requires the menu to be redrawn. The menu is redrawn on the GUI to display a subset of features corresponding to the selection made. The UPK label and assignment does not change when the menu is redrawn—remaining available to the user to select.

Features can be assigned to the UPK in different ways. For example, a user invokes the features of a hard key and a number of soft keys on various menus. When the user locates a soft key to replace the existing UPK 338 in FIG. 3 or add to the UDM 461 in FIG. 4, the UPK button is depressed for a predetermined duration, for example between 2 to 5 seconds. The instrument will beep and display a message indicating that the feature previously executed will replace the existing UPK and UPK label 348 for the embodiment in FIG. 3 or add to the UDM 461 in the embodiment of FIG. 4. In a variation to the above example, depressing the UPK button for a predetermined duration will cause the setup dialog to be displayed. The setup dialog shows a list of choices which can be assigned to UPK 338. The user then makes a selection on the dialog which alters the behavior and label of the UPK.

In another variation of programming a UPK, after a user locates a feature to add to the UPK, the soft key is depressed for a predetermined duration, for example between 2 to 5 seconds. The instrument will beep and display a message indicating that the feature will replace the existing UPK and UPK label 348 of FIG. 3 or that the feature will be added to the UDM 461 of FIG. 4.

In yet another embodiment the UPK assignment change is done programmatically over a remote computer interface such as a LAN or the Internet, for example.

While the embodiments described above constitute exemplary embodiments of the invention, it should be recognized that the invention can be varied in numerous ways without departing from the scope thereof. It should be understood that the invention is only defined by the following claims.

1. An instrument, comprising:
a user key to which a feature of the instrument is assigned by a user;
a graphical user interface displaying a menu, the menu listing a subset of features from a hierarchal menu tree;
a user key label associated with the user key, the user key label displayed on the graphical user interface and indicating the feature assigned by the user; and
the user key label indicating the same user-assigned feature on the graphical user interface when the menu is redrawn to display on the graphical user interface a different subset of features from the hierarchal menu tree.

2. The instrument in claim 1, wherein the user key is placed adjacent to or is a part of the graphical user interface.

3. The instrument in claim 2, wherein the user key is a physical button adjacent to the graphical user interface or a virtual button on the graphical user interface.

4. The instrument in claim 1, wherein the feature executes an immediate action or displays the subset of features on the graphical user interface.

5. The instrument in claim 1, wherein the user key is programmed by keeping the user key selected for a predetermined duration.

6. The instrument in claim 1, further comprising:
soft key buttons on the instrument, the soft key buttons operable with the subset of features, one feature from the subset of features being selected when one of the soft key buttons is pushed; and
the graphical user interface redrawing the menu when the one feature from the subset of features is selected from the hierarchal menu tree.

7. The instrument in claim 6, whereby the user key is programmed by keeping a desired one of the soft key buttons selected for a predetermined duration.

8. The instrument in claim 6, further comprising labeled hard keys operable to invoke the subset of features.

9. The instrument in claim 1, wherein the user key selects a top-level menu feature.

10. The instrument of claim 1, wherein the instrument is an electronic test and measurement apparatus.

11. A computer readable media containing code thereon, the code providing instructions to an instrument for executing the steps of:
assigning a feature of the instrument to a user key in response to a user action;
associating a user key label with the user key;
displaying a menu and the user key label on a graphical user interface, the menu listing a subset of features from a hierarchal menu tree; and
redrawing the menu to display on the graphical user interface a different subset of features from the hierarchal menu tree while displaying the user key label identifying the same feature assigned to the user key.

12. The computer readable media as recited in claim 11, wherein the user key is a physical button adjacent to the graphical user interface or a virtual button on the graphical user interface.

13. The computer readable media as recited in claim 11, wherein the instructions further comprise the step of programming the user key by keeping the user key selected for a predetermined duration.

14. The computer readable media as recited in claim 11, wherein the instructions further comprise executing the steps of selecting a feature from the subset of features and redrawing the menu in response to pushing of a soft key button.

15. The computer readable media as recited in claim 11, wherein the instructions further comprise executing the steps of displaying a menu of features when invoked by a labeled hard key.

16. The computer readable media as recited in claim 11 wherein the feature executes an immediate action or displays a subset of features on the graphical user interface.
